(19) United States
(12) Patent Application Publication
(10) Pub. No.: US 2022/0156692 A1
(43) Pub. Date: May 19, 2022

(54) INFORMATION PROCESSING APPARATUS, INFORMATION PROCESSING METHOD, AND NON-TRANSITORY STORAGE MEDIUM

(71) Applicant: TOYOTA JIDOSHA KABUSHIKI KAISHA, Toyota-shi (JP)

(72) Inventors: Akira SASAKI, Miyoshi-shi (JP); Osamu IZUMIDA, Nagoya-shi (JP); Satoshi KOMAMINE, Nagoya-shi (JP); Koshi ITO, Okazaki-shi (JP); Ayana TAKESHITA, Kasugai-shi (JP); Daisuke MURAKAMI, Okazaki-shi (JP)

(73) Assignee: TOYOTA JIDOSHA KABUSHIKI KAISHA, Toyota-shi (JP)

(21) Appl. No.: 17/520,295

(22) Filed: Nov. 5, 2021

(30) Foreign Application Priority Data
Nov. 19, 2020 (JP) 2020-192425

(51) Int. Cl. G06Q 10/08; G06Q 50/30

(52) U.S. Cl. CPC G06Q 10/0838; G06Q 50/30; G06Q 10/0833

(57) ABSTRACT

An information processing apparatus manages delivery of a predetermined product that is delivered on a regular basis to a specific place associated with a user. The information processing apparatus estimates, when the user is to temporarily stay at a place of stay other than the specific place, a necessary quantity that is a quantity of the predetermined product needed by the user during a period of stay at the place of stay, and generates a delivery plan for the predetermined product in such a way that the predetermined product is delivered in the necessary quantity to the place of stay at a timing of stay of the user at the place of stay.

### CROSS REFERENCE TO THE RELATED APPLICATION

This application claims the benefit of Japanese Patent Application No. 2020-192425, filed on Nov. 19, 2020, which is hereby incorporated by reference herein in its entirety.

### BACKGROUND

### Technical Field

The present disclosure relates to a technology that is used to provide a service of delivering a product to a user on a regular basis.

### Description of the Related Art

Patent Literature 1 discloses a regular delivery service system. In the regular delivery service system disclosed in Japanese Patent Laid-Open No. 2002-216044, a server apparatus stores regular delivery destination information. Furthermore, the server apparatus receives, from a user terminal, a request to temporarily change a delivery destination, together with desired delivery destination information. Moreover, the server apparatus notifies, of a change of delivery destination, an operator terminal managing delivery to a usual delivery destination of a user. Moreover, the server apparatus instructs an operator terminal managing delivery to a desired delivery destination to deliver a product temporarily to the desired delivery destination.

### CITATION LIST

### Patent Literature

Patent Literature 1: Japanese Patent Laid-Open No. 2002-216044

### SUMMARY

An object of the present disclosure is to provide a technology capable of increasing convenience of a service of delivering a product to a user on a regular basis.

An information processing apparatus according to a first mode of the present disclosure is

an information processing apparatus for managing delivery of a predetermined product that is delivered on a regular basis to a specific place associated with a user, and the information processing apparatus may include a controller configured to:

estimate, when the user is to temporarily stay at a place of stay other than the specific place, a necessary quantity that is a quantity of the predetermined product needed by the user during a period of stay at the place of stay; and

generate a delivery plan for the predetermined product in such a way that the predetermined product is delivered in the necessary quantity to the place of stay at a timing of stay of the user at the place of stay.

An information processing method according to a second mode of the present disclosure is

an information processing method performed by a computer for managing delivery of a predetermined product that is delivered on a regular basis to a specific place associated with a user, and the information processing method may include:

estimating, when the user is to temporarily stay at a place of stay other than the specific place, a necessary quantity that is a quantity of the predetermined product needed by the user during a period of stay at the place of stay; and

generating a delivery plan for the predetermined product in such a way that the predetermined product is delivered in the necessary quantity to the place of stay at a timing of stay of the user at the place of stay.

A non-transitory storage medium according to a third mode of the present disclosure is

a non-transitory storage medium storing a program for causing a computer for managing delivery of a predetermined product that is delivered on a regular basis to a specific place associated with a user to perform an information processing method, where the information processing method may include:

estimating, when the user is to temporarily stay at a place of stay other than the specific place, a necessary quantity that is a quantity of the predetermined product needed by the user during a period of stay at the place of stay; and

generating a delivery plan for the predetermined product in such a way that the predetermined product is delivered in the necessary quantity to the place of stay at a timing of stay of the user at the place of stay.

According to the present disclosure, convenience of a service of delivering a product to a user on a regular basis may be increased.

### BRIEF DESCRIPTION OF THE DRAWINGS

FIG. 1 is a diagram illustrating a schematic configuration of a delivery management system according to an embodiment;

FIG. 2 is a block diagram schematically illustrating an example of a functional configuration of each of a user terminal and a management server;

FIG. 3 is a diagram illustrating an example of a table structure for user information;

FIG. 4 is a diagram illustrating an example of a table structure for a first delivery plan;

FIG. 5 is a diagram illustrating an example of a table structure for a second delivery plan;

FIG. 6 is a flowchart illustrating a flow of information processing that is performed by a controller of the management server;

FIG. 7 is a diagram illustrating an example of a table structure for a first delivery plan;

FIG. 8 is a flowchart illustrating a flow of information processing that is performed by a controller of a management server;

FIG. 9 is a diagram illustrating an example of a table structure for user information; and

FIG. 10 is a diagram illustrating an example of a table structure for a second delivery plan.

### DESCRIPTION OF THE EMBODIMENTS

An information processing apparatus according to the present disclosure may manage delivery of a predetermined product to a user. Here, the predetermined product is delivered to a specific place on a regular basis. The specific place is a place that is associated with the user. For example, the specific place is a place where the user lives, or a place where the user works. The user may freely set the specific place that is to be made a place where the predetermined product is to be delivered on a regular basis. Furthermore, the predetermined product is a product that is consumed daily by the user, for example. Moreover, the predetermined product is delivered to the specific place at a predetermined interval. At this time, a quantity per delivery of the predetermined product to the specific place may be set in advance by the user. For example, the user may determine the quantity per delivery of the predetermined product by taking into account a quantity of the predetermined product that is consumed by the user himself/herself in a delivery interval.

The user possibly temporarily stays at places other than the specific place for trips, business trips and the like. Furthermore, the user may need the predetermined product that the user uses daily at the specific place, also at a place of stay where the user temporarily stays. Accordingly, in the case where the user is to temporarily stay at a place of stay other than the specific place, the information processing apparatus may generate a delivery plan for delivering the predetermined product to the place of stay.

More specifically, the information processing apparatus includes a controller. The controller may estimate a necessary quantity of the predetermined product, when the user is to temporarily stay at a place of stay other than the specific place. The necessary quantity here is a quantity of the predetermined product that is needed by the user during a period of stay at the place of stay. The necessary quantity is not the same all the time, and the quantity may be different depending on a length of the period of stay of the user at the place of stay. Accordingly, the controller may estimate the necessary quantity of the predetermined product for each temporary stay of the user at the place of stay.

Furthermore, the controller may generate a delivery plan for the predetermined product in such a way that the predetermined product is delivered in the necessary quantity to the place of stay at a timing of stay of the user at the place of stay. The predetermined product may thus be delivered to the user in an appropriate quantity even when the user is to temporarily stay at a place other than the specific place. As a result, the user may use the predetermined product in the necessary quantity at the place of stay.

In the following, specific embodiments of the present disclosure will be described with reference to the drawings. Dimensions, materials, shapes, relative positions and the like of structural components described in the present embodiments are not intended to limit the technical scope of the present disclosure unless stated otherwise.

### First Embodiment

(Outline of System)

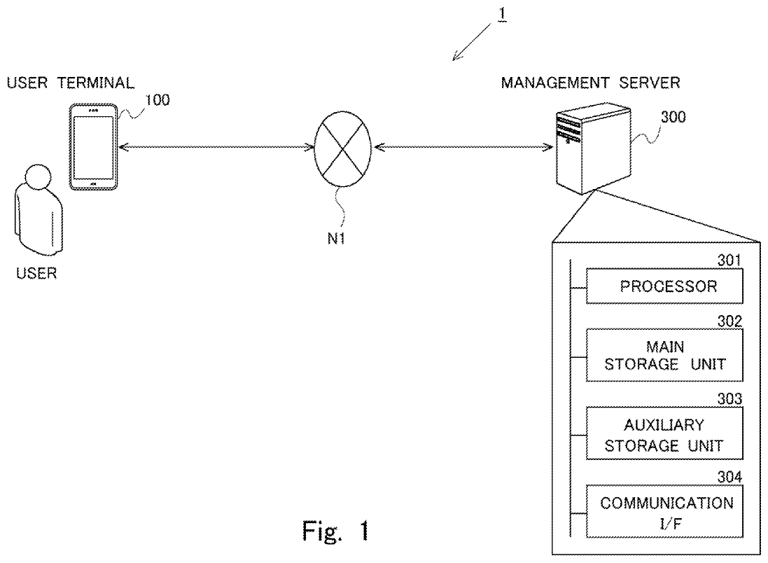

FIG. 1 is a diagram illustrating a schematic configuration of a delivery management system according to a present embodiment. A delivery management system 1 is a system for delivering a predetermined product to home of a user on a regular basis. The predetermined product here is a product that is consumed daily by the user. That is, the predetermined product is determined in advance by the user to be a product that needs to be replenished regularly. In the present embodiment, the home of the user corresponds to “specific place” according to the present disclosure.

As illustrated in FIG. 1, the delivery management system 1 includes a user terminal 100 and a management server 300. In the delivery management system 1, the user terminal 100 and the management server 300 are connected to each other via a network N1. As the network N1, a wide area network (WAN), which is a worldwide public communication network such as the Internet, or a mobile communication network for mobile phones may be adopted, for example.

The management server 300 is a server for managing delivery of the predetermined product to the user. The management server 300 includes a general computer. The computer forming the management server 300 includes a processor 301, a main storage unit 302, an auxiliary storage unit 303, and a communication interface (a communication I/F) 304.

The processor 301 here is a central processing unit (CPU) or a digital signal processor (DSP), for example. The main storage unit 302 is a random access memory (RAM), for example. The auxiliary storage unit 303 is a read only memory (ROM), a hard disk drive (HDD), or a flash memory, for example. The auxiliary storage unit 303 may also include a removable medium (a removable recording medium). The removable medium here is a USB memory, an SD card, or a disk recording medium such as a CD-ROM, a DVD disc, or a Blu-ray disc, for example. The communication I/F 304 is a local area network (LAN) interface board, or a wireless communication circuit for wireless communication, for example.

The auxiliary storage unit 303 stores an operating system (OS), various programs, various information tables, and the like. Various types of control as described later for delivering the predetermined product to the user are implemented by the processor 301 loading the programs stored in the auxiliary storage unit 303 into the main storage unit 302 and executing the same. Note that functions of the management server 300 may be partially or wholly implemented by a hardware circuit such as an ASIC or an FPGA. The management server 300 does not necessarily have to be implemented by a single physical configuration, and may alternatively be configured by a plurality of computers that operate in conjunction with each other. In the present embodiment, the management server 300 corresponds to “information processing apparatus” according to the present disclosure.

In the management server 300, a first delivery plan for delivering the predetermined product to the home of the user on a regular basis is stored. Normally, the predetermined product is delivered to the home of the user based on the first delivery plan stored in the management server 300. However, the user may temporarily stay at places other than home (such as an accommodation facility) for trips, business trips and the like. In this case, the management server 300 receives user information from the user terminal 100 via the network N1. The user information here is information about a schedule of temporary stay of the user at a place other than home.

The user terminal 100 is a terminal that is associated with the user. As the user terminal 100, a personal computer, a smartphone, a tablet computer, or a wearable terminal may be cited as an example. Schedule information about a schedule of the user including a trip, a business trip or the like is input to the user terminal 100 by the user. The user terminal 100 generates the user information based on the schedule information, and transmits the user information to the management server 300.

Then, the management server 300 generates a second delivery plan based on the user information received from the user terminal 100. The second delivery plan is a delivery plan for delivering the predetermined product to a place of stay where the user is to temporarily stay. Then, the predetermined product is delivered to the place of stay based on the second delivery plan generated by the management server 300. The user may thus use the predetermined product at the place of stay even without the user taking the predetermined product to the place of stay himself/herself.

(Functional Configuration)

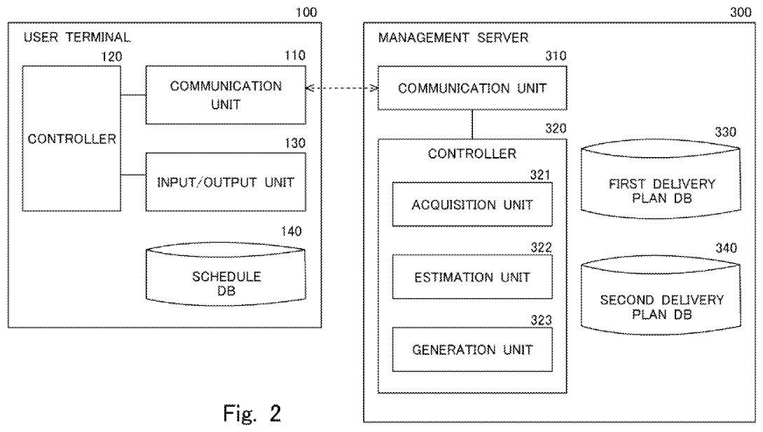

Next, a functional configuration of each of the user terminal 100 and the management server 300 forming the delivery management system 1 will be described with reference to FIG. 2. FIG. 2 is a block diagram schematically illustrating an example of the functional configuration of each of the user terminal 100 and the management server 300.

(User Terminal)

The user terminal 100 includes a communication unit 110, a controller 120, an input/output unit 130, and a schedule database (a schedule DB) 140. The communication unit 110 includes a function of connecting the user terminal 100 to the network N1. The communication unit 110 may be implemented by a communication interface provided in the user terminal 100. For example, the communication unit 110 may communicate with other apparatuses including the management server 300 via the network N1, by using a mobile communication service such as 3rd Generation (3G) or a long term evolution (LTE).

The controller 120 includes a function of performing arithmetic processing for controlling the user terminal 100. The controller 120 may be implemented by a processor provided in the user terminal 100.

The input/output unit 130 includes a function of receiving an input operation that is performed by the user, and a function of outputting information that is to be presented to the user. For example, the input/output unit 130 includes a touch panel display. The schedule information of the user is input to the user terminal 100 via the input/output unit 130. The controller 120 stores the schedule information input via the input/output unit 130, in the schedule DB 140.

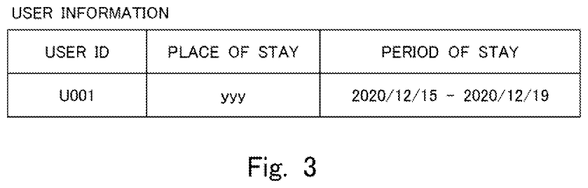

Furthermore, in the case where a schedule of the user to temporarily stay at a place of stay other than home is included in the schedule information stored in the schedule DB 140, the controller 120 generates the user information to be transmitted to the management server 300. FIG. 3 is a diagram illustrating an example of a table structure for the user information to be transmitted from the user terminal 100 to the management server 300. As illustrated in FIG. 3, the user information includes a user ID field, a place-of-stay field, and a period-of-stay field. A user ID that is identification information for specifying the user is input in the user ID field. Information indicating the place of stay where the user is to temporarily stay is input in the place-of-stay field. Information indicating a scheduled period of stay of the user at the place of stay is input in the period-of-stay field. Information input in each field of the user information is acquired from the schedule information stored in the schedule DB 140. The controller 120 performs a process of transmitting the generated user information to the management server 300 using the communication unit 110.

(Management Server)

The management server 300 includes a communication unit 310, a controller 320, a first delivery plan database (a first delivery plan DB) 330, and a second delivery plan database (a second delivery plan DB) 340. The communication unit 310 includes a function of connecting the management server 300 to the network N1. The communication unit 310 may be implemented by a communication I/F 304. The controller 320 includes a function of performing arithmetic processing for controlling the management server 300. The controller 320 may be implemented by the processor 301. The controller 320 performs a process of receiving the user information transmitted from the user terminal 100, by using the communication unit 310.

Furthermore, the controller 320 includes an acquisition unit 321, an estimation unit 322, and a generation unit 323 as functional units. The acquisition unit 321 acquires the user information that is received from the user terminal 100. The acquisition unit 321 also acquires the first delivery plan that is stored in advance in the first delivery plan DB 330.

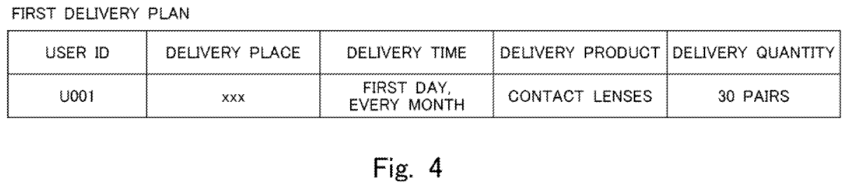

As described above, the first delivery plan is a delivery plan for delivering the predetermined product to the home of the user on a regular basis. FIG. 4 is a diagram illustrating an example of a table structure for the first delivery plan stored in the first delivery plan DB 330. As illustrated in FIG. 4, the first delivery plan includes a user ID field, a delivery place field, a delivery time field, a delivery product field, and a delivery quantity field. The user ID is input in the user ID field. Information indicating the location of the home of the user is input in the delivery place field. Information indicating the time of delivery of the predetermined product to the home of the user is input in the delivery time field. The time that is input in the delivery time field is the time of delivery to the home of the user performed on a regular basis. In FIG. 4, “first day, every month” is indicated as an example of the time of delivery to the home of the user performed on a regular basis. Information indicating the predetermined product to be delivered to the home of the user on a regular basis is input in the delivery product field. In FIG. 4, “contact lenses” are indicated as an example of the predetermined product (the delivery product). Information indicating the quantity per delivery of the predetermined product that is delivered to the home of the user on a regular basis is input in the delivery quantity field. In FIG. 4, “30 pairs” is indicated as an example of the delivery quantity. Moreover, a plurality of types of products may be input in the delivery product field as the predetermined product (the delivery product). In this case, information indicating the quantity per delivery of each product is input in the delivery quantity field.

The first delivery plan DB 330 may store the first delivery plan for each of a plurality of users. In this case, the acquisition unit 321 acquires, from the first delivery plan DB 330, the first delivery plan corresponding to the user ID that is included in the user information received from the user terminal 100.

Furthermore, the estimation unit 322 estimates the necessary quantity that is the quantity of the predetermined product that is needed by the user during the period of stay at the place of stay. The estimation unit 322 estimates the necessary quantity of the predetermined product based on the user information and the first delivery plan acquired by the acquisition unit 321.

As described above, information pieces indicating the delivery time and the quantity per delivery related to delivery of the predetermined product to the home of the user performed on a regular basis are included in the first delivery plan. The quantity of the predetermined product that is needed by the user in a delivery interval may be estimated from these information pieces. For example, in the first delivery plan illustrated in FIG. 4, it is indicated that “30 pairs” of “contact lenses” as the predetermined product are delivered on “first day, every month”. According to such a first delivery plan, it may be estimated that the user needs 30 pairs of contact lenses every month. As described above, information indicating the scheduled period of stay of the user at the place of stay is included in the user information. The necessary quantity of the predetermined product may be estimated based on a relationship between a length of the scheduled period of stay and a length of the delivery interval according to the first delivery plan. For example, the user information illustrated in FIG. 3 indicates that the scheduled period of stay of the user at the place of stay is “2020/12/15-2020/12/19”, that is, five days. If the user needs 30 pairs of contact lenses every month, it can be assumed that the user needs about five pairs of contact lenses in five days. In such a case, it is estimated by the estimation unit 322 that the necessary quantity of contact lenses for the user in the scheduled period of stay at the place of stay is five pairs.

Furthermore, the generation unit 323 generates the second delivery plan about the predetermined product. The second delivery plan here is a delivery plan for delivering the predetermined product in a necessary quantity to a place of stay included in the user information, at a timing when the user is to stay at the place of stay. The generation unit 323 generates the second delivery plan based on the user information acquired by the acquisition unit 321 and the necessary quantity of the predetermined product estimated by the estimation unit 322.

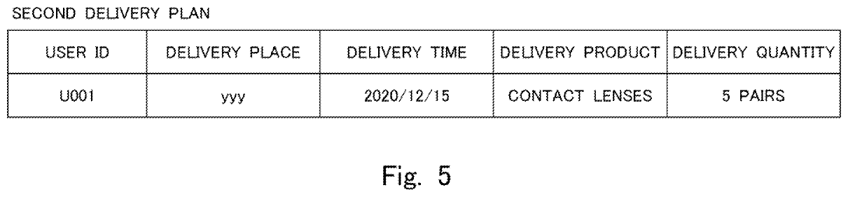

FIG. 5 is a diagram illustrating an example of a table structure for the second delivery plan generated by the generation unit 323. As illustrated in FIG. 5, the second delivery plan includes, like the first delivery plan, a user ID field, a delivery place field, a delivery time field, a delivery product field, and a delivery quantity field. The user ID is input in the user ID field. Information indicating the place of stay where the user is to temporarily stay is input in the delivery place field. That is, information indicating the place of stay included in the user information is input in the delivery place field. Information indicating the time of delivery of the predetermined product to the place of stay is input in the delivery time field. That is, a start date of the scheduled period of stay included in the user information is input in the delivery time field. Information indicating the predetermined product to be delivered to the delivery place is input in the delivery product field. Information indicating the quantity of delivery of the predetermined product to be delivered to the place of stay is input in the delivery quantity field. The necessary quantity of the predetermined product estimated by the estimation unit 322 is input in the delivery quantity field. In the present embodiment, the second delivery plan corresponds to “delivery plan” according to the present disclosure.

The controller 320 stores the second delivery plan generated by the generation unit 323 in the second delivery plan DB 340. Then, the predetermined product is delivered to the place of stay of the user based on the second delivery plan stored in the second delivery plan DB 340.

Furthermore, the controller 320 performs a process of transmitting the second delivery plan generated by the generation unit 323 to the user terminal 100 by using the communication unit 310. At the user terminal 100, the controller 120 performs a process of receiving the second delivery plan transmitted from the management server 300, by using the communication unit 110. Furthermore, the controller 120 outputs the received second delivery plan via the input/output unit 130. The user is thereby notified of the second delivery plan.

As described above, in the delivery management system 1, delivery of product is performed based not only on the first delivery plan stored in the first delivery plan DB 330, but also on the second delivery plan stored in the second delivery plan DB 340. Because delivery of product is performed based on the second delivery plan, the predetermined product may be delivered to the user in an appropriate quantity even when the user is temporarily staying at a place of stay. Furthermore, because the user is notified of the second delivery plan, the user may grasp the predetermined product that is scheduled to be delivered to the place of stay when the user is to stay at the place of stay, and the quantity of delivery of such predetermined product.

(Flow of Information Processing)

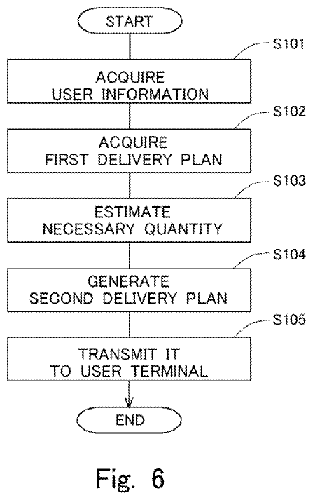

In the following, a flow of information processing, according to the present embodiment, that is performed by the management server 300 will be described with reference to FIG. 6. FIG. 6 is a flowchart illustrating a flow of information processing that is performed by the controller 320 of the management server 300.

In the present flow, first, in S101, the user information received from the user terminal 100 is acquired. Next, in S102, the first delivery plan stored in the first delivery plan DB 330 is acquired. The processes in S101 and S102 are performed by the acquisition unit 321.

Next, in S103, the necessary quantity of the predetermined product during a period of stay when the user is to temporarily stay at a place of stay (the place of stay included in the user information) is estimated based on the user information acquired in S101 and the first delivery plan acquired in S102. The process in S103 is performed by the estimation unit 322. Next, in S104, the second delivery plan is generated based on the user information acquired in S101 and the necessary quantity of the predetermined product estimated in S103. The second delivery plan generated in S103 is stored in the second delivery plan DB 340. The process in S104 is performed by the generation unit 323. Next, in S105, the second delivery plan generated in S103 is transmitted to the user terminal 100.

As described above, with the delivery management system 1 according to the present embodiment, the predetermined product that is normally delivered to the home of the user on a regular basis may be delivered to the user in an appropriate quantity even when the user is temporarily staying at a place of stay other than home. As a result, the user is able to use the predetermined product in the necessary quantity even at the place of stay.

(Modification)

Next, a modification of the present embodiment will be described. In the present modification, the user is scheduled to temporarily stay at a plurality of places of stay other than home. In this case, a schedule of stay of the user at each place of stay is included in the schedule information stored in the schedule DB 140 of the user terminal 100. Here, information indicating each place of stay, and information indicating the scheduled period of stay of the user at each place of stay are included in the user information that is transmitted from the user terminal 100 to the management server 300.

At the controller 320 of the management server 300, the estimation unit 322 estimates the necessary quantity of the predetermined product for each place of stay, based on the user information. At this time, the estimation unit 322 estimates the necessary quantity according to the scheduled period of stay of the user at each place of stay. Furthermore, the generation unit 323 generates the second delivery plan in such a way that the predetermined product is delivered to each place of stay in the necessary quantity at a timing when the user is to stay at each place of stay. That is, the delivery time of the predetermined product to each place of stay included in the second delivery plan is determined based on the scheduled period of stay of the user at each place of stay included in the user information.

According to the present modification, even when the user is to stay at a plurality of places of stay, the predetermined product may be delivered to each place of stay in an appropriate quantity. As a result, the user is able to use the predetermined product in the necessary quantity at each place of stay.

### Second Embodiment

In a present embodiment, a plurality of types of products are delivered to the home of the user on a regular basis. In this case, the plurality of types of products are included, as predetermined products (delivery products), in the first delivery plan stored in the first delivery plan DB 330 of the management server 300.

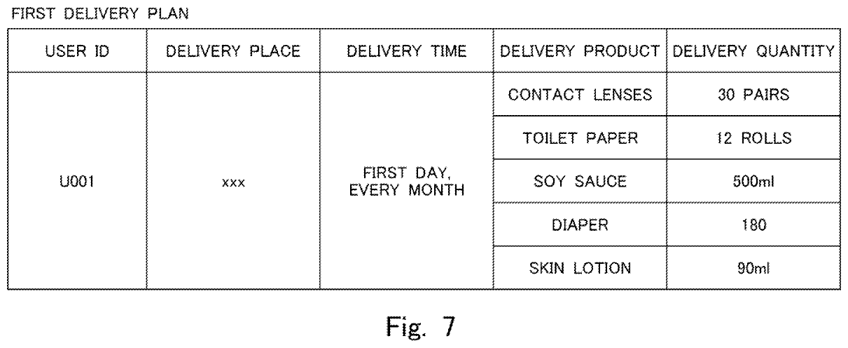

FIG. 7 is a diagram illustrating an example of a table structure, according to the present embodiment, for the first delivery plan that is stored in the first delivery plan DB 330. As illustrated in FIG. 7, information pieces indicating the plurality of types of products that are delivered to the home of the user on a regular basis are input in the delivery product field of the first delivery plan according to the present embodiment. In FIG. 7, as the plurality of types of predetermined products (delivery products), “contact lenses”, “toilet paper”, “soy sauce”, “diaper”, and “skin lotion” are indicated as examples. Furthermore, information indicating the quantity per delivery of each product is input in the delivery quantity field. In FIG. 7, “30 pairs”, “12 rolls”, “500 ml”, “180”, and “90 ml” are indicated as examples in relation to the quantity per delivery of respective products.

Note that, when temporarily staying at a place of stay other than the home of the user, the user does not necessarily need, at the place of stay, all of the plurality of types of products that are delivered to the home of the user on a regular basis. Even when a product is included in the first delivery plan as the predetermined product (the delivery product), a product that is not needed by the user at a place of stay does not have to be delivered to the place of stay.

Accordingly, in the present embodiment, at the time of generating the second delivery plan, the controller 320 of the management server 300 selects, from the plurality of types of predetermined products included in the first delivery plan, a product as a target to be delivered to the place of stay of the user. At this time, the controller 320 selects, as the target to be delivered to the place of stay, a predetermined product that will be needed by the user in a period of stay at the place of stay.

(Flow of Information Processing)

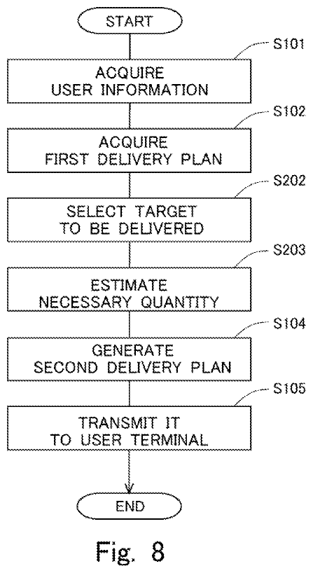

In the following, a flow of information processing, according to the present embodiment, that is performed by the management server 300 will be described with reference to FIG. 8. FIG. 8 is a flowchart illustrating a flow of information processing that is performed by the controller 320 of the management server 300. In the flow illustrated in FIG. 8, processes performed in steps S101, S102, S104, and S105 are the same as the processes performed in the steps with the same reference signs illustrated in FIG. 6. Accordingly, a description of the processes performed in these steps will be omitted.

In the present flow, the process in S202 is performed subsequent to S102. In S202, a product that is a target to be delivered to the place of stay of the user is selected from a plurality of types of predetermined products included in the first delivery plan acquired in S102. A predetermined product that is needed by the user also at the place of stay is specified in advance by the user, from the plurality of types of predetermined products included in the first delivery plan. In S202, the product as the target to be delivered to the place of stay of the user is selected based on such specification by the user. At this time, a plurality of types of products may be selected as the targets to be delivered to the place of stay of the user.

Next, in S203, a necessary quantity that is needed during the period of stay when the user is to temporarily stay at the place of stay is estimated in relation to the predetermined product selected in S202 as the target to be delivered. Next, in S104, the second delivery plan is generated. The second delivery plan generated at this time includes the predetermined product that is selected as the target to be delivered to the place of stay of the user and the necessary quantity thereof. Accordingly, for example, in the case where “contact lenses” are selected in S202 as the target to be delivered to the place of stay of the user from the plurality of types of predetermined products (the delivery products) included in the first delivery plan illustrated in FIG. 7, a second delivery plan that is the same as the second delivery plan illustrated in FIG. 5 is generated in S104.

As described above, with the delivery management system 1 according to the present embodiment, even in a case where a plurality of types of products are delivered to the home of the user on a regular basis, a necessary product may be delivered in an appropriate quantity to the user who is temporarily staying at a place of stay other than home. In other words, delivery of an unnecessary product to the user who is temporarily staying at a place of stay other than home may be prevented.

(First Modification)

Next, a modification of the present embodiment will be described. Products needed by the user at a place of stay other than the home of the user when the user is temporarily staying at the place of stay may be different depending on the purpose of stay. The purpose of stay here is the purpose of temporary stay of the user at a place of stay. For example, in the case where the purpose of stay of the user is business trip, products needed by the user at the place of stay are products that are used only by the user himself/herself. By contrast, in the case where the purpose of stay of the user is a family trip, products needed by the user at the place of stay are products that are used by the user himself/herself and products that are used by the family of the user. Accordingly, in the present modification, the controller 320 of the management server 300 selects a product as the target to be delivered to the place of stay of the user based on the purpose of stay.

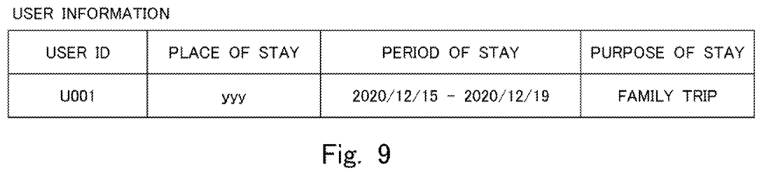

FIG. 9 is a diagram illustrating an example of a table structure, according to the present modification, for user information that is transmitted from the user terminal 100 to the management server 300. As illustrated in FIG. 9, in the present modification, the user information includes a purpose-of-stay field, in addition to the user ID field, the place-of-stay field and the period-of-stay field. Information indicating the purpose of stay is input in the purpose-of-stay field. In FIG. 9, “family trip” is indicated as an example of the purpose of stay.

At this time, the controller 320 of the management server 300 acquires the information indicating the purpose of stay included in the user information received from the user terminal 100. Then, the controller 320 selects the product as the target to be delivered to the place of stay, based on the purpose of stay of the user. In the present modification, a predetermined product that will be needed by the user at a place of stay is specified in advance by the user for each purpose of stay. The product as the target to be delivered to a place of stay of the user is selected based on such specification by the user.

According to the present modification, the management server 300 generates the second delivery plan matching the purpose of stay of the user. For example, a case is assumed where the second delivery plan is generated based on the first delivery plan illustrated in FIG. 7. At this time, in the case where the purpose of stay included in the user information is “business” and the predetermined product that is needed by the user at the place of stay is only “contact lenses”, a second delivery plan that is the same as the second delivery plan illustrated in FIG. 5 is generated.

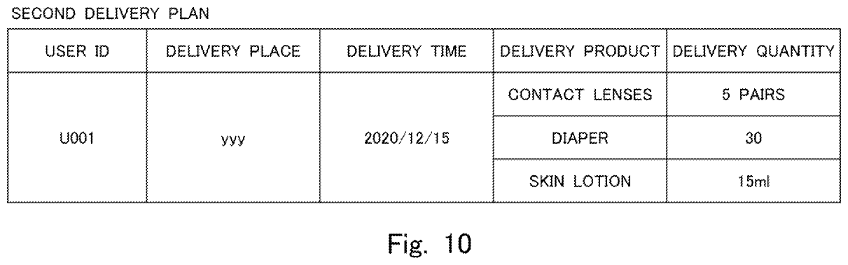

By contrast, in the case where the purpose of stay included in the user information is “family trip”, the second delivery plan as illustrated in FIG. 10 is generated. FIG. 10 is a diagram illustrating an example of a table structure, according to the present modification, for the second delivery plan. Here, in the case where the purpose of stay included in the user information is “family trip”, “contact lenses”, “diaper”, and “skin lotion” are selected as the predetermined products that will be needed by the user at the place of stay. Accordingly, “contact lenses”, “diaper”, and “skin lotion” are input in the delivery product field in the second delivery plan illustrated in FIG. 10 as the predetermined products to be delivered to the place of stay. Furthermore, information indicating the delivery quantity of each product to be delivered to the place of stay is input in the delivery quantity field in the second delivery plan illustrated in FIG. 10.

When the second delivery plan is generated in the manner described above, a product matching the purpose of stay may be delivered in an appropriate quantity to the user who is temporarily staying at a place of stay other than home.

(Second Modification)

Note that the user information transmitted from the user terminal 100 to the management server 300 may include accompanying person information instead of the information indicating the purpose of stay. The accompanying person information here is information about a person who accompanies the user at the time of temporary stay at the place of stay. In this case, the controller 320 of the management server 300 acquires the accompanying person information included in the user information received from the user terminal 100. Then, the controller 320 selects the product as the target to be delivered to the place of stay based on the accompanying person of the user. In the present modification, the predetermined product that is needed by the user at the place of stay is specified in advance by the user for each accompanying person. The product as the target to be delivered to the place of stay of the user is selected based on such specification by the user.

The second delivery plan matching the accompanying person of the user is thereby generated. As a result, a product matching the accompanying person may be delivered in an appropriate quantity to the user who is temporarily staying at a place of stay other than home.

### Other Embodiments

The embodiments described above are merely examples, and the present disclosure may be changed and implemented as appropriate within the scope of the disclosure. Furthermore, processes and means described in the present disclosure may be freely combined to the extent that no technical conflict exists.

Furthermore, a process that is described to be performed by one apparatus may be shared and performed by a plurality of apparatuses. Processes described to be performed by different apparatuses may be performed by one apparatus. Which function is to be implemented by which hardware configuration (server configuration) in a computer system may be flexibly changed.

The present disclosure may also be implemented by supplying computer programs for implementing the functions described in the embodiments described above to a computer, and by one or more processors of the computer reading out and executing the programs. Such computer programs may be provided to the computer by a non-transitory computer-readable storage medium that can be connected to a system bus of the computer, or may be provided to the computer through a network. The non-transitory computer-readable storage medium may be any type of disk including magnetic disks (floppy (registered trademark) disks, hard disk drives (HDDs), etc.) and optical disks (CD-ROMs, DVD discs, Blu-ray discs, etc.), and any type of medium suitable for storing electronic instructions, such as read-only memories (ROMs), random access memories (RAMs), EPROMs, EEPROMs, magnetic cards, flash memories, or optical cards.

What is claimed is:

1. An information processing apparatus for managing delivery of a predetermined product that is delivered on a regular basis to a specific place associated with a user, the information processing apparatus comprising a controller configured to:
estimate, when the user is to temporarily stay at a place of stay other than the specific place, a necessary quantity that is a quantity of the predetermined product needed by the user during a period of stay at the place of stay; and
generate a delivery plan for the predetermined product in such a way that the predetermined product is delivered in the necessary quantity to the place of stay at a timing of stay of the user at the place of stay.

2. The information processing apparatus according to claim 1, wherein the controller estimates the necessary quantity based on a delivery time and a quantity per delivery when the predetermined product is delivered to the specific place on a regular basis, and a scheduled period of stay of the user at the place of stay.

3. The information processing apparatus according to claim 1, wherein, in a case where a plurality of types of products are delivered to the specific place on a regular basis, the controller is further configured to select, as a target to be delivered to the place of stay, the predetermined product that is needed by the user during the period of stay at the place of stay, from the plurality of types of products.

4. The information processing apparatus according to claim 3, wherein
the controller is further configured to acquire information about a purpose of a temporary stay of the user at the place of stay, and
the controller selects the predetermined product as the target to be delivered to the place of stay, based on the purpose.

5. The information processing apparatus according to claim 3, wherein
the controller is further configured to acquire information about an accompanying person who accompanies the user at a time of a temporary stay of the user at the place of stay, and
the controller selects the predetermined product as the target to be delivered to the place of stay, based on the accompanying person.

6. The information processing apparatus according to claim 1, wherein, in a case where there are a plurality of the places of stay where the user is scheduled to temporarily stay, the controller
estimates the necessary quantity of the predetermined product for each place of stay, and
generates the delivery plan in such a way that the predetermined product is delivered in the necessary quantity to each place of stay at a timing of stay of the user at the place of stay in question.

7. The information processing apparatus according to claim 1, wherein the controller is further configured to receive, from a user terminal associated with the user, user information including information about the place of stay and information about a scheduled period of stay of the user at the place of stay.

8. The information processing apparatus according to claim 1, wherein the controller is further configured to notify the user of the delivery plan.

9. An information processing method performed by a computer for managing delivery of a predetermined product that is delivered on a regular basis to a specific place associated with a user, the information processing method comprising:
estimating, when the user is to temporarily stay at a place of stay other than the specific place, a necessary quantity that is a quantity of the predetermined product needed by the user during a period of stay at the place of stay; and
generating a delivery plan for the predetermined product in such a way that the predetermined product is delivered in the necessary quantity to the place of stay at a timing of stay of the user at the place of stay.

10. The information processing method according to claim 9, wherein the necessary quantity is estimated based on a delivery time and a quantity per delivery when the predetermined product is delivered to the specific place on a regular basis, and a scheduled period of stay of the user at the place of stay.

11. The information processing method according to claim 9, further comprising selecting, in a case where a plurality of types of products are delivered to the specific place on a regular basis, the predetermined product that is needed by the user during the period of stay at the place of stay as a target to be delivered to the place of stay, from the plurality of types of products.

12. The information processing method according to claim 11, further comprising acquiring information about a purpose of a temporary stay of the user at the place of stay, wherein
the predetermined product as the target to be delivered to the place of stay is selected based on the purpose.

13. The information processing method according to claim 11, further comprising acquiring information about an accompanying person who accompanies the user at a time of a temporary stay of the user at the place of stay, wherein
the predetermined product as the target to be delivered to the place of stay is selected based on the accompanying person.

14. The information processing method according to claim 9, wherein, in a case where there are a plurality of the places of stay where the user is scheduled to temporarily stay,
the necessary quantity of the predetermined product is estimated for each place of stay, and
the delivery plan is generated in such a way that the predetermined product is delivered in the necessary quantity to each place of stay at a timing of stay of the user at the place of stay in question.

15. The information processing method according to claim 9, further comprising receiving, from a user terminal associated with the user, user information including information about the place of stay and information about a scheduled period of stay of the user at the place of stay.

16. The information processing method according to claim 9, further comprising notifying the user of the delivery plan.

17. A non-transitory storage medium storing a program for causing a computer for managing delivery of a predetermined product that is delivered on a regular basis to a specific place associated with a user to perform an information processing method, wherein the information processing method includes:
estimating, when the user is to temporarily stay at a place of stay other than the specific place, a necessary quantity that is a quantity of the predetermined product needed by the user during a period of stay at the place of stay; and
generating a delivery plan for the predetermined product in such a way that the predetermined product is delivered in the necessary quantity to the place of stay at a timing of stay of the user at the place of stay.

18. The non-transitory storage medium according to claim 17, wherein, in the information processing method, the necessary quantity is estimated based on a delivery time and a quantity per delivery when the predetermined product is delivered to the specific place on a regular basis, and a scheduled period of stay of the user at the place of stay.

19. The non-transitory storage medium according to claim 17, wherein the information processing method further comprises selecting, in a case where a plurality of types of products are delivered to the specific place on a regular basis, the predetermined product that is needed by the user during the period of stay at the place of stay as a target to be delivered to the place of stay, from the plurality of types of products.

20. The non-transitory storage medium according to claim 17, wherein, in the information processing method, in a case where there are a plurality of the places of stay where the user is scheduled to temporarily stay,
the necessary quantity of the predetermined product is estimated for each place of stay, and
the delivery plan is generated in such a way that the predetermined product is delivered in the necessary quantity to each place of stay at a timing of stay of the user at the place of stay in question.
